(19) United States
(12) Patent Application Publication
(10) Pub. No.: US 2019/0017667 A1
(43) Pub. Date: Jan. 17, 2019

(54) LED (LIGHT EMITTING DIODE) LUMINAIRES, HEAT DISSIPATION MODULES AND METHODS OF USE

(71) Applicant: Lumican Corporation, Edmonton (CA)

(72) Inventors: David MITCHELL, Edmonton (CA); Zhigang LIANG, Toronto (CA); Jinsong SHENG, Houston, TX (US); Andrew GRESCHNER, Edmonton (CA)

(21) Appl. No.: 15/652,211

(22) Filed: Jul. 17, 2017

(51) Int. Cl. F21S 8/08; F21V 23/00; F21V 23/02; F21V 29/77; F21V 29/51; F21V 17/00; F21V 5/04; F21V 29/71

(52) U.S. Cl. CPC F21S 8/086; F21V 23/002; F21V 23/02; F21V 29/773; F21Y 2115/10; F21V 17/002; F21V 5/04; F21V 29/713; F21V 29/51

(57) ABSTRACT

An apparatus includes a mast; an LED (light emitting diode) module at or near a top of the mast; a power supply at or near a base of the mast; and wiring connecting the LED module and power supply. A heat dissipation module includes a heat sink housing defining an internal chamber; a plurality of heat sink fins arranged about the housing; a plurality of grooves defined in an interior surface of a base of the heat sink housing within the internal chamber; and heat transfer fluid, within the internal chamber, the heat transfer fluid being provided in a quantity, and selected to have a boiling point, sufficient to provide the heat dissipation module with an operating range of heat flux, into the internal chamber across the base and out through the plurality of heat sink fins, within which the heat transfer fluid continuously cycles between a gas phase where liquefied heat transfer fluid boils within and is expelled from the plurality of grooves, and a liquid phase where gaseous heat transfer fluid condenses and drains into the plurality of grooves without immersing the internal surface of the base. COB LED powered luminaires may include interchangeable lenses with different respective output light beams for field customization and optimization.

### TECHNICAL FIELD

This document relates to LED luminaires, heat dissipation modules, and methods of use.

### BACKGROUND

Heat sinks are known for LED lamps, with a hollow cylindrical heat sink with fins, with grooves on a bottom surface of the inside of the heat sink, and a heat transfer fluid that operates via latent heat of vaporization. LED lamps are known with integral power supplies. High mast streetlights and stadium lights use SMD (surface mount device) arrays of LED lights.

### SUMMARY

A street luminaire is disclosed, comprising a heat dissipation module, a power supply assembly, and light emitting module and a housing assembly.

A luminaire is disclosed comprising: a housing; an LED (light emitting diode) module; a heat dissipation module; a power supply; and wiring connecting the LED module and power supply.

An apparatus is disclosed comprising: a mast; an LED (light emitting diode) module at or near a top of the mast; a power supply at or near a base of the mast; and wiring connecting the LED module and power supply.

A heat dissipation module comprising: a heat sink housing defining an internal chamber; a plurality of heat sink fins arranged about the housing; a plurality of grooves defined in an interior surface of a base of the heat sink housing within the internal chamber; and heat transfer fluid, within the internal chamber, the heat transfer fluid being provided in a quantity, and selected to have a boiling point, sufficient to provide the heat dissipation module with an operating range of heat flux, into the internal chamber across the base and out through the plurality of heat sink fins, within which the heat transfer fluid continuously cycles between a gas phase where liquefied heat transfer fluid boils within and is expelled from the plurality of grooves, and a liquid phase where gaseous heat transfer fluid condenses and drains into the plurality of grooves without immersing the internal surface of the base.

A high mast luminaire is also disclosed comprising: a housing; a COB (chip on board) LED (light emitting diode) module; a heat dissipation module that withdraws heat from the COB LED module during operation using the latent heat of vaporization of a heat transfer fluid within the heat dissipation module; a power supply; and wiring connecting the COB LED module and the power supply.

A luminaire comprising: a housing; an LED (light emitting diode), such as a COB (chip on board) LED module; a heat dissipation module; and a plurality of lenses, with each lens being structured to interchangeably mount to the housing to, in use, shape light emitted from the COB LED module into a respective light beam that is different from the respective light beams produced by the other lenses of the plurality of lenses.

The heat dissipation module may comprise a heat sink, which is constructed of a metal material with high thermal conductance. The module may be a hollow cylindrical shape, and radially finned, with the bottom of the module in close contact with the light emitting module. The cylinder may be filled with a novel low boiling point organic liquid which uses the latent heat of vaporization to maintain a low junction temperature. Junction temperature is the highest operating temperature of the actual semiconductor in an electronic device. In operation, it is higher than case temperature and the temperature of the part's exterior. The difference is equal to the amount of heat transferred from the junction to case multiplied by the junction-to-case thermal resistance.

The radiator may have a hollow cylinder, made of a metal material having good heat transfer performance. The outer circumference of the cylinder may be uniformly and radially finned. The bottom side of the bottom of the cylinder may be solidly connected to the heat source, typically a light emitting module. The upper surface of the bottom of the cylinder may comprise small scale grooves over as much of the surface as possible. The hollow chamber may have injected within it a small volume of organic fluid, having a low boiling point, which collects in the groove structures. The solid-vapour phase transition of the organic fluid may be used to draw heat away from the heat source.

The light module may comprise one or more LED COB source, and the light may be shaped into various required light distribution patterns by the use of various swappable/changeable lenses, reflectors and cutoff shields which may be secured to the heat dissipation module.

In some cases embodiments aim at reducing the effective junction temperature by the use of low boiling point organic fluid, which will use the latent heat of vaporization to keep the LED junction temperature low and the thermal efficiency high. Such may allow the use of a COB chip, and effective secondary light shaping, to achieve the desired light distribution pattern using a standard mounting interface, resulting in zero retooling to change distribution patterns, and allowing field adjustment of the light distribution pattern.

In some cases an ultra-high power LED street lamp is disclosed, comprising a power supply, radiator assembly, light emitting module and a shell component (the shell module can choose different shapes). The heat dissipation module and light emitting module may adopt a combined design, The cooling components may be matched with a variety of different types of LED light source, reducing process cost. The radiator may have a plurality of small-scale grooves to achieve gas-liquid composite phase heat, heat intensity, high thermal efficiency, small chip temperature gap, low junction temperature, and long life. A cover for power components, a back cover and the bottom may be designed with air through holes to cool components and power components at a certain distance.

The liquid may fill the micro grooves on the opposite side of heat transfer chamber in parallel to the heat source. As the temperature rises higher than the boiling temperature, each micro groove and mini-chamber may become a type of tea pot. The surface of the liquid may begin as a meniscus and as heat builds-up it may change to a bubble without a pointing curve. This bubble will eventually burst with all the liquid inside the chamber exploding and begin a phase exchange from liquid to vapor. The explosion is directed towards the opposite side of the heat source, creating an active extraction of the heat from the source. The vaporized steam may then fill up the chamber creating additional pressure. Once the liquid touches the walls, a slightly lower temperature is achieved from the radiator fins. This process dispatches heat to form a film of liquid along the wall and pulled down by gravity to and fill the empty space of the grooves. The difference of temperature between the surface of the heat source and the remote end of the heat sink may be only 3-5 degrees, and the difference may drive the internal cycle continuously to prevent the temperature rising beyond failure rate. High powered LED luminaries may be designed starting at 500 W with 140 lumen/W, for example 170 lumen/W efficiency. LEDS may be produced in the range of 500w-2000w or higher. Testing has shown there is little to no degradation of the LED chips with the disclosed heat sink technology. This equates to longer lifespan of the LED chips, or other heat source technologies requiring cooling and stability. An additional advantage of this invention is to further design powerful luminaries in compact sizes with lighter weights and long life expectancy. Embodiment of this document may use any heat source as an external energy drive to form a consistent vortex of liquid/vapor. The cycle may result in an efficient transfer of heat from the source, in this case keeping the LED chip from failing. In turn, the chamber may expand the heat-dispatching space and with the help of peripheral fins, equilibrium is reached.

In various embodiments, there may be included any one or more of the following features: The housing assembly has a rounded shape, with venting on the top and/or on the sides. The power supply is 15 m or more away from the LED module. The power supply is 50 m or more away from the LED module. The apparatus or luminaire is a streetlight. The apparatus or luminaire is a stadium light. The wiring extends through a hollow interior of the mast. The power supply is mounted within the hollow interior, with an access door positioned in a side wall of the mast adjacent the power supply. The power supply is mounted within a compartment mounted to an external side wall of the mast. The power supply is mounted above a ground surface. The power supply is at least 3 m above the ground surface. A second power supply mounted within a housing that mounts the LED module. The power supply and the second power supply are operated in a passive switching fully redundant configuration. A photocell connected to the power supply. The LED module is situated at least partially in a housing, and the housing comprises a plurality of mast adaptors each interchangeably connectable to a connection point on the housing, and each sized and shaped for a different size or shape of mast, with one of the plurality of mast adaptors connected to the connection point. A method comprising repairing or replacing the power supply. The heat dissipation module comprises: a heat sink housing defining an internal chamber; a plurality of heat sink fins arranged about the heat sink housing; a plurality of grooves defined in an interior surface of a base of the heat sink housing within the internal chamber; and the heat transfer fluid, within the internal chamber, the heat transfer fluid being provided in a quantity, and selected to have a boiling point, sufficient to provide the heat dissipation module with an operating range of heat flux, into the internal chamber across the base and out through the plurality of heat sink fins, within which the heat transfer fluid continuously cycles between a gas phase where liquefied heat transfer fluid boils within and is expelled from the plurality of grooves, and a liquid phase where gaseous heat transfer fluid condenses and drains into the plurality of grooves without immersing the internal surface of the base. The plurality of grooves are sized, and the heat transfer fluid is selected, such that within the operating range of heat flux the heat transfer fluid forms a concave meniscus within the plurality of grooves. The plurality of grooves are sized, and the heat transfer fluid is selected, such that within the operating range of heat flux, when viewing the plurality of grooves in cross-section, a minimum height of a base of the meniscus is less than half of the height of the heat transfer fluid within the groove. The heat transfer fluid comprises an organic fluid that is liquid at room temperature. The organic fluid comprises an acetone derivative. The heat sink housing has an encircling side wall, and the plurality of heat sink fins are radial fins arranged about an external surface of the encircling side wall. The encircling side wall is cylindrical. The heat dissipation module is formed as a disc whose axial length is less than half of a maximum diameter of the heat dissipation module. The internal chamber is defined by the base, the encircling side wall, and a top wall of the heat sink housing. The top wall comprises a heat transfer fluid injection port. During operation within the operating range of heat flux, respective temperatures of the top wall and base are within 5 degrees Celsius of each other. The base forms a thermally conductive plate. The thermally conductive plate has a planar heat-receiving external surface. The heat dissipation module comprises aluminum. The boiling point of the heat transfer fluid is between 40 and 65 degrees Celsius. The boiling point of the heat transfer fluid is below 50 degrees Celsius. Each of the plurality of grooves has a cross-sectional shape with a width of 0.07 mm to 1.2 mm, and a depth of 0.07 to 1.2 mm. Each of the plurality of grooves is straight and runs between opposed perimeter edges of the base. A combination comprising the heat dissipation module connected to a heat source. The heat source comprises an LED (light emitting diode) module. The combination forming a high mast streetlight or stadium light. The heat sink housing is located within an external housing, which comprises plural vents to direct air flow across the plurality of heat sink fins. Operating the heat dissipation module to dissipate heat from a heat source. A lens mounted to direct light from the COB LED module. The COB LED module is mounted within a reflector cup. A cut off shield surrounding the COB LED module. The apparatus or luminaire formed as a cobrahead luminaire. Each lens produces a respective light beam that has a different beam angle than other lenses of the plurality of lenses. Each lens produces a respective light beam that has a different light focus distance than other lenses of the plurality of lenses. Each lens produces a respective light beam that has a different light pattern than other lenses of the plurality of lenses. The COB LED module is structured to produce light of a color temperature within the range of about 1800 to about 2200 K. Selecting a lens of the plurality of lenses. Mounting the luminaire, with the selected lens, to a mast.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a perspective view of a cobrahead-style LED (light-emitting diode) luminaire head.

FIG. 2 is a bottom plan view of the luminaire of FIG. 1.

FIG. 3 is a top plan view of the luminaire of FIG. 1.

FIG. 4 is a front end elevation view of the luminaire of FIG. 1.

FIG. 5 is a rear end elevation view of the luminaire of FIG. 1.

FIG. 6 is a side elevation view of the luminaire of FIG. 1.

FIG. 7 is an exploded perspective view of the luminaire of FIG. 1.

FIG. 8 is an exploded perspective view of the heat dissipation module of the luminaire of FIG. 1.

FIG. 9 is a bottom plan view of the heat dissipation module of FIG. 8 with the LED module installed.

FIG. 10 is a top plan view of the heat dissipation module of FIG. 8.

FIG. 11 is a section view taken along the 11-11 section lines of FIG. 10.

FIGS. 12 and 13 are perspective and top plan views, respectively, of a grooved base plate wall of the heat dissipation module of FIG. 8.

FIG. 14 is a close-up view of the area delineated by dashed lines in FIG. 13.

FIG. 15 is a conceptual section view of the heat dissipation module of FIG. 8 illustrating the process of heat transfer and phase change of the heat transfer fluid contained within the heat dissipation module during operation.

FIG. 16 is a close-up view of the area delineated by dashed lines in FIG. 15.

FIG. 17 is a perspective view of another embodiment of a cobrahead luminaire installed on a cantilever arm of a mast.

FIG. 18 is an exploded perspective view of the luminaire of FIG. 17.

FIG. 19 is a perspective view of the mast and luminaire of FIG. 17.

FIG. 20 is a side elevation view of a luminaire with an SMD (surface-mount-device) LED module, showing light lines.

FIG. 21 is a side elevation view of a luminaire with an SMD LED module, showing light lines.

FIG. 22 is a plan view of a COB LED module.

FIG. 23 is a perspective view of another embodiment of a luminaire for a stadium lighting application.

FIG. 24 is a section view of the heat dissipation module from the luminaire of FIG. 23.

FIG. 25 is a side elevation view of the luminaire of FIG. 23.

FIG. 26 is a bottom plan view of the luminaire of FIG. 23.

FIG. 27 is a top plan view of the luminaire of FIG. 23.

FIG. 28 is an exploded perspective view of the luminaire of FIG. 23.

FIG. 29 is a perspective view of the luminaire of FIG. 23.

FIG. 30 is a bottom perspective view of a further embodiment of a luminaire.

FIG. 31 is a bottom plan view of the luminaire of FIG. 30.

FIG. 32 is front end elevation view of the luminaire of FIG. 30.

FIG. 33 is a side elevation view of the luminaire of FIG. 30.

FIG. 34 is a rear end elevation view of the luminaire of FIG. 30.

FIG. 35 is a top perspective view of the luminaire of FIG. 30.

FIG. 36 is a top plan view of the luminaire of FIG. 30.

FIGS. 37 and 38 are side elevation and perspective exploded views of the luminaire of FIG. 30.

### DETAILED DESCRIPTION

Immaterial modifications may be made to the embodiments described here without departing from what is covered by the claims.

LED lights are being used to replace traditional lighting for urban roads, highways, town squares, and parks. In the past, outdoor lamps and lanterns traditionally used high-pressure sodium and metal halide light sources. The scale of urban construction has rapidly grown, and road lighting has become a major opportunity for increased energy savings and safety. As LED technology becoming increasingly mature, with research and improvements in applied practice, LED road lighting can now offer advanced control methods, high efficiency, and good stability.

Lights using super bright LEDs as a light source use only 20% of the energy used by a conventional sodium lamp, thus reducing carbon footprint in line with current trends. However, LEDs face the same challenge as many other light sources, in that only a portion of the electrical input is converted to light, with most of the wasted energy being converted to heat. If the heat is not distributed and controlled in an efficient and timely manner, such heat may seriously affect LED lamp life, especially in high-power LED lights, which generate relatively more heat than smaller-scale lights. An inability to properly manage heat may lead to the phenomena of light attenuation.

At present, to address the issue of heat dissipation, standard market LED lamps use traditional aluminum radiators. However, such radiators have relatively low thermal efficiencies, which is a limiting factor for high power, high brightness special applications, such as high mast street lighting. With improvements in LED chip power and integration, LED chip cooling problems are becoming more and more serious. LED chip temperatures that rise past a threshold point may lead to fast life attenuation, and serious or fatal problems for LED peak wavelength, optical power, luminous flux and many other performance parameters.

At the same time, conventional aluminum extrusion heat sinks are often fixed in size and shape. Thus, a conventional heat sink may only be suitable for mounting a light source adapted to its specific size. Differences in size or shape may lead to a poor fit, so for a lamp of same power but different size of the light source, a corresponding mold for the radiator may have to be redesigned. A proper-fit is important because after the light source is installed, a lack of proper contact between the light source substrate and the radiator heating surface in a poorly fitted combination may create unwanted heat resistance that negatively affects heat dissipation. Using a forging process to solve the above problems may work but only for low power applications and a great cost.

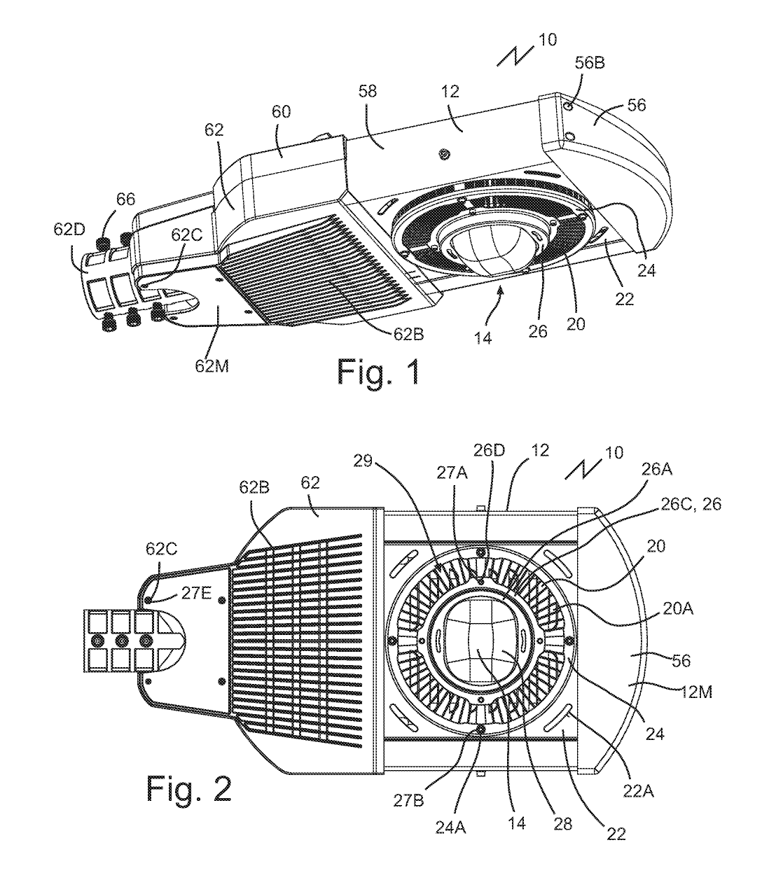

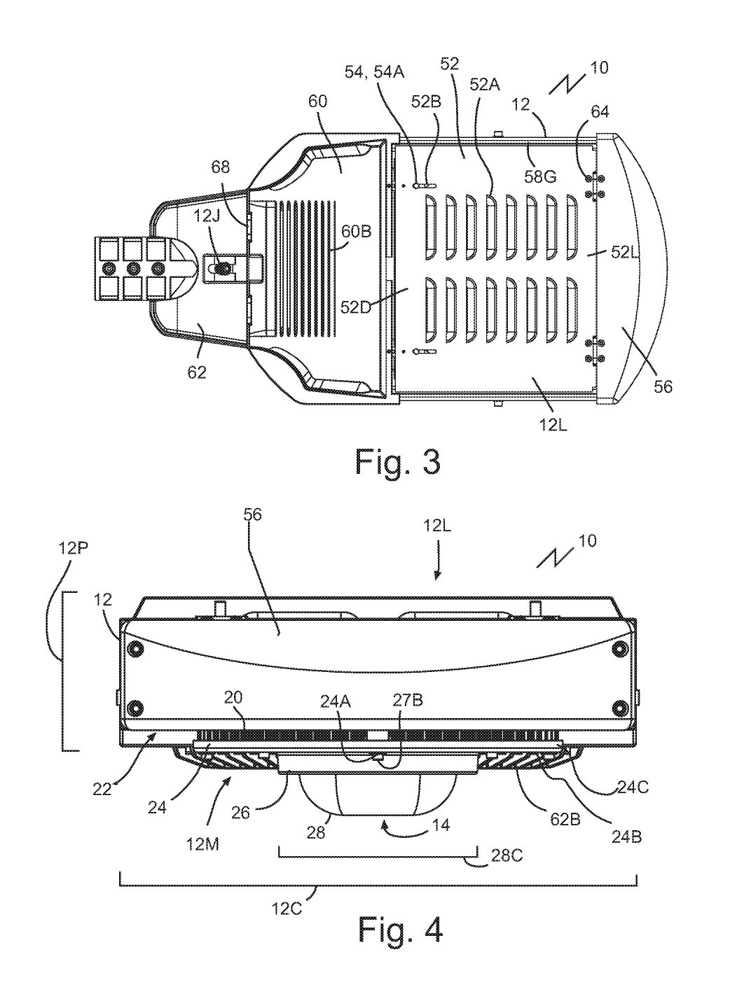

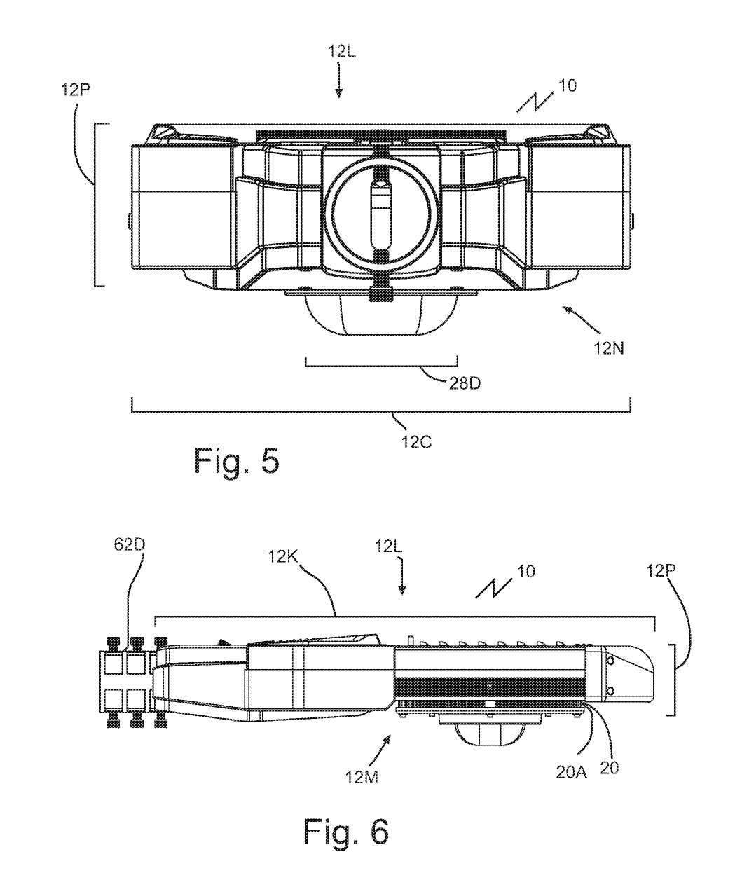

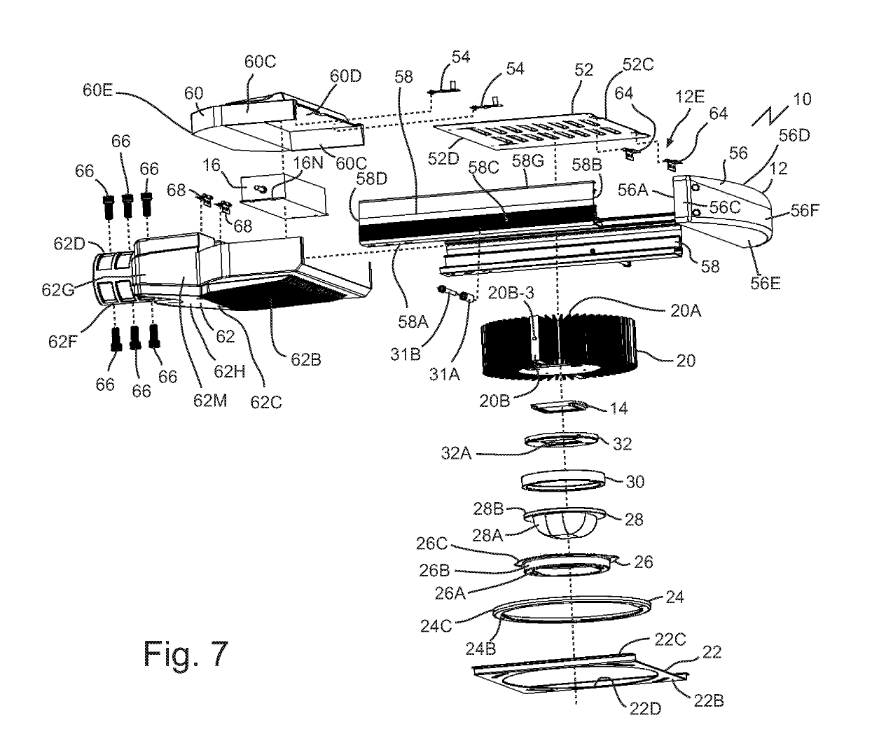

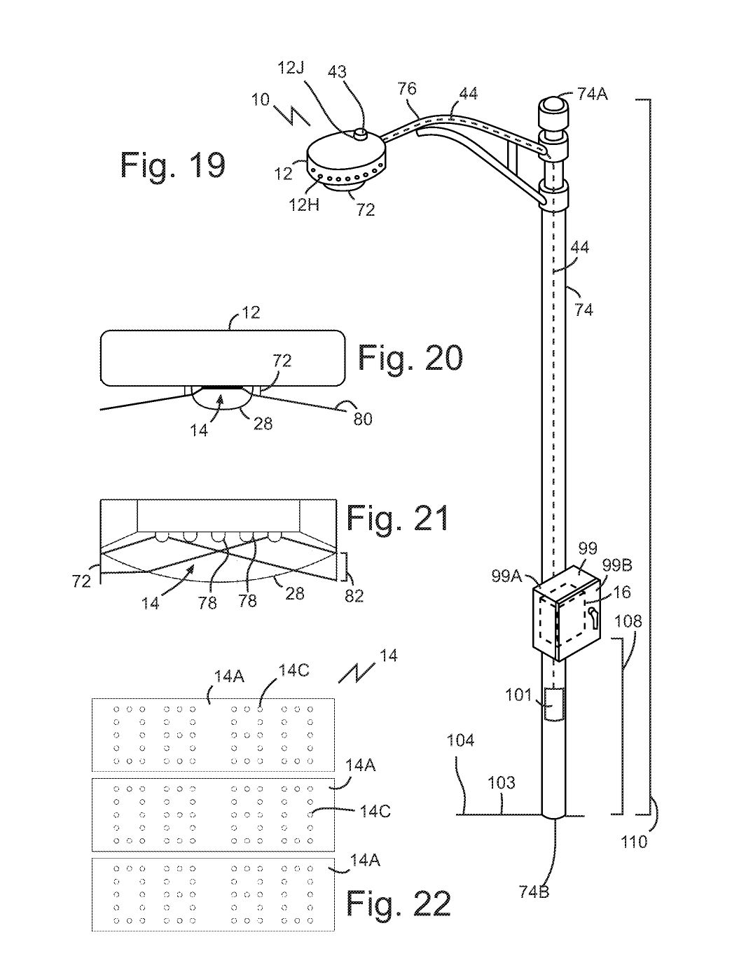

Referring to FIGS. 1 and 7 a luminaire 10 is illustrated, having a housing 12, an LED (light emitting diode) module 14, a heat dissipation module 20, and a power supply 16. The luminaire 10 illustrated is a cobrahead-style streetlight, which is so called due to its resemblance to the animal itself. Referring to FIGS. 2-6, a cobrahead luminaire 10 often has a housing 12 that has the appearance of a paddle or a relatively flat plate, generally defining top and bottom faces 12L and 12M, respectively whose maximum length 12K (excluding pole connector adaptor 62D) and width 12C dimensions far exceed (for example at least two times larger for width 12C and at least three times larger for length 12K) a thickness dimension 12P between the faces 12L, 12M. Referring to FIGS. 2 and 3, the faces 12L and 12M may have a rectangular appearance, or that of another suitable shape such as a teardrop or oval shape. Referring to FIG. 19, the cobrahead luminaire 10 is always oriented such that the bottom face 12M faces down directed toward a roadway 104. Heat dissipation module 20 may have the form of a relatively flat disc as shown, to fit within or otherwise cooperate with a cobrahead luminaire 10. The chassis or housing 12 may be generally cylindrical.

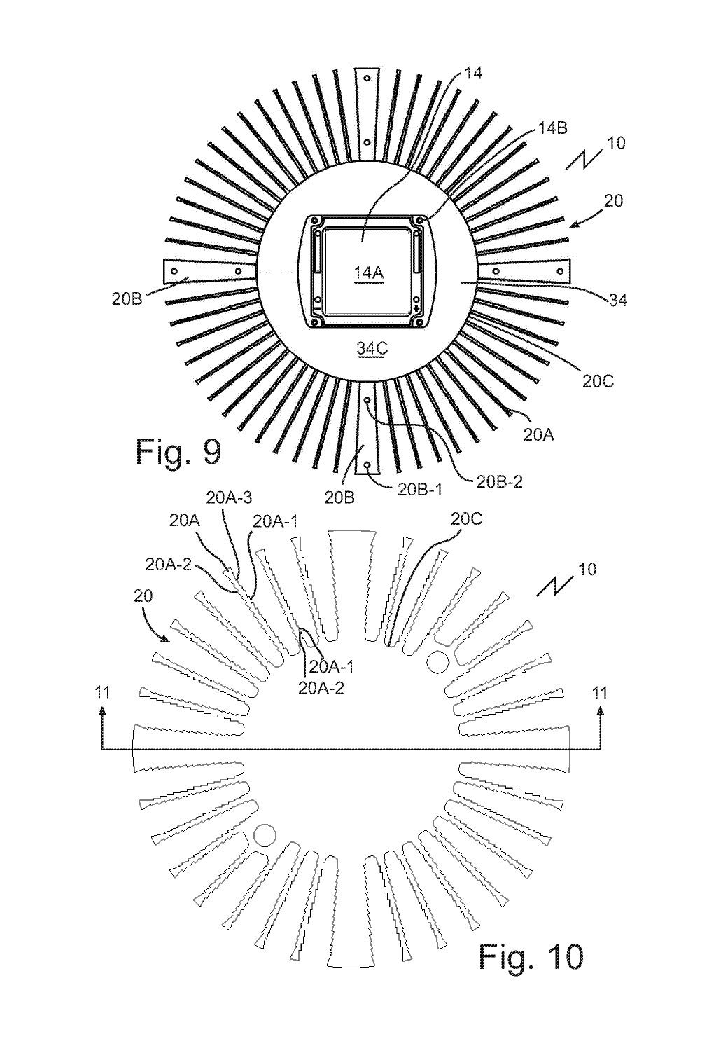

Referring to FIG. 7, an exploded view of the luminaire 10 is illustrated. Two types of parts are shown—parts that make up the housing 12, and parts that make up or support light production. Starting with the latter, a lens 28, LED light module 14, and heat dissipation module 20 are illustrated. Referring to FIG. 9, the LED light module 14 may mount directly (or indirectly through conductive components) to a heat receiving face wall 34C of module 20, or in other configurations where the module 14 and module 20 are in thermal contact to permit the module 20 to draw heat from module 14. Referring to FIG. 7, the LED module 14 may be fixed to heat dissipation module 20 via a bracket 32. Bracket 32 may have an aperture 32A through which light from module 14 is permitted to pass. Referring to FIGS. 2 and 7, other components may be present, such as, in sequential order from outer to inner components, one or more of a baffle plate 22, a cap 24, a lens gland 26, lens 28, a seal nut 30, bracket 32, and LED module 14.

Referring to FIGS. 2, 4, and 9, lens gland 26 may secure lens 28 to heat dissipation module 20, for example via fasteners 27A passed through holes 26D in flange 26C, and into holes 20B-2 of heat dissipation module 20, with holes 20B-2 being aligned with holes 26D. Gland 26 may have a suitable structure, such as provided by an inner flange 26A projected from a lower part of a collar 26B, and an outer flange 26C projected from an upper part of collar 26B. Referring to FIG. 7, the lens gland 26 may compress seal nut 30, which may be an o-ring or other suitable gasket, between bracket 32 and lens 28 to prevent ingress of moisture and other fluids into lens 28. Lens 28 may have a suitable structure, such as a transparent dome 28A depending from a support collar 28B. Collar 28B may sit within a seat defined by flange 26A and collar 26B of lens gland 26.

Referring to FIGS. 2 and 7, baffle plate 22 and cap 24 may cooperate to mount or support heat dissipation module 20 to housing 12. Baffle plate 22 may have an aperture 22D sized to fit around an external circumference of module 20, such that plate 22 sits part way between end walls 34C and 36C of module 20 when assembled. Baffle plate 22 may form part of and be secured to housing 12 by tip portion 56 and rear base portion 62 of housing 12. Baffle plate 22 may have a suitable structure, such as a pair of side walls 22A, from which inner plate 22B projects from a lower part of the side walls 2D, with outer flanges 22C projecting from an upper part of each side wall 22A. When assembled the outer flanges 22C may be supported by rod portions 58 of housing 12. Referring to FIG. 2, vents, such as arcuate vents 22A may be present in plate 22 to facilitate air flow.

Referring to FIGS. 2, 4, and 7, cap 24 may have a suitable shape, such as a collar 24C from which an inner flange 24B projects. A lower part of heat dissipation module 20 may sit within a receptacle defined by collar 24C and flange 24B. Referring to FIGS. 2, 4, and 9, cap 24 may be secured to heat dissipation module, for example via fasteners 27B passed through holes 24A in cap 24, and into holes 20B-1 of module 20, with holes 20B-1 aligning with holes 24A. Referring to FIG. 2, an air gap or vent 29 may be defined between collar cap 24 and lens gland 26 to facilitate air flow through housing 12 and over radial fins 20A of heat dissipation module 20.

Referring to FIG. 7, a power supply 16 may be connected, for example by wiring (not shown), to provide power to LED module 14. A power supply, also known as an LED driver, is an electrical device which regulates the power to an LED or a string (or strings) of LEDs. An LED driver may respond to the changing needs of the LED, or LED circuit, by providing a constant quantity of power to the LED as its electrical properties change with temperature. An LED driver may be a self-contained power supply which has outputs that are matched to the electrical characteristics of the LED or LEDs. LED drivers may offer dimming by means of pulse width modulation circuits and may have more than one channel for separate control of different LEDs or LED arrays. The power level of the LED may be maintained constant by the LED driver as the electrical properties change throughout the temperature increases and decreases seen by the LED or LEDs. Without the proper driver, the LED may become too hot and unstable, therefore causing poor performance or failure. In some cases a battery (not shown) may be present, with or without an inverter to provide A/C (alternating current).

Referring to FIGS. 1 and 7 the power supply 16 may be mounted internally within the housing 12 via a suitable mechanism. In the example shown, the supply 16 is positioned within a sealed compartment 62M formed in portion 62. Referring to FIGS. 1, 2, and 7, supply 16 may be secured within compartment 62M via a suitable mechanism, such as by bracket (not shown) or fasteners 27E that pass through holes 62C in portion 62, and into holes 16N in supply 16. An IP65 or IP67 compartment, or other suitable sealed compartment, may be used for compartment 62M, for the termination of power and control wired, and the installation of a power supply 16. The IP mark, International Protection Mark (IEC 529), also known as Ingress Protection Mark, categorises the degree of protection provided by housings and enclosures against the intrusion by foreign bodies, including hands and fingers, dust, accidental contact, and water. The standard is controlled by the International Electrotechnical Commission (IEC) and consists of a simple to use numbering system which provides a consistant standard by which manufacturers can identify the protection provided. All wiring to the LED module 14 and photocell socket 12J may be prewired to a terminal strip in the IP65 chamber or compartment 62M, allowing for quick wiring connection to the power supply module at the pole or in the chamber. Where applicable the compartment 62M may include a passive switching module to allow for parallel redundant operation of power supplies for increased uptime of the light head. In some cases a redundant power supply is provided in the head and on the mast supporting the head.

Referring to FIG. 7, housing 12 may have a suitable structure. The housing 12 may form a jacket that surrounds and supports the internal lighting components of the luminaire 10. The housing 12 may define a compartment that partially or fully encloses the internal components. Housing 12 may include one or more of a nose cup or portion 56, side rod portions 58, a rear top portion 60, a rear base portion 62, baffle plate 22, and an access panel 52.

Referring to FIG. 7, side rod portions 58 may have a suitable structure. Flanges 58A and 58G may project inward from side walls 58F. Fasteners 31B may pass through holes 58C in side walls 58F and into holes 20B-3 (of heat dissipation module 20), which are aligned with hole 58C when luminaire 10 is assembled. Spacers 31A may be provided to fill a space gap between side walls 58F and module 20. Side rod portions 58 may define axial ends 58B and 58D.

Referring to FIGS. 2 and 7, nose portion 56 may have a suitable structure. Nose cup portion 56 may define a receptacle that receives axial ends 58B of side rod portions 58, as well as part of baffle plate 22. Referring to FIG. 1, holes 56B may be provided to receive fasteners (not shown) to connect to side rod portions 58. Referring to FIG. 7, nose portion 56 may be formed by side walls 56C, a top wall 56D, a base wall 56E, and a nose wall 56F.

Referring to FIGS. 3 and 7, rear top portion 60 may form a suitable structure. Portion 60 may define a receptacle that receives axial ends 58D of side rod portions 58, as well as part of access panel 52. The top portion 60 may mount on top of rear base portion 62 to enclose axial ends 58D of side rod portions 58. Referring to FIG. 3, fins 60B may be provided in portion 60 to provide a heat sink function to housing 12, for example for compartment 62M. Referring to FIG. 7, portion 60 may be formed by side walls 60C, a top wall 60D, and a rear wall 60E.

Referring to FIGS. 3 and 7, access panel 52 may form a suitable structure. The example shown is an example of a panel 52 that permits tool-less entry into the interior 12E of the housing 12. Panel 52 may form a hinged connection to nose portion 56, for example by axial end 52C of panel 52 mounting to portion 56 via hinges 64. Panel 52 may form a quick-release connection to rear top portion 60, for example by axial end 52D of panel 52 providing slots 52B for receipt of pins 54A from locking arms 54, which extend from portion 60. Other structures may be used, including a housing 12 whose interior 12E permits entry via tools, keys, locks, disassembly, or by other mechanisms. Vents 52A may be provided to facilitate air flow through housing 12 across radial fins 20A of heat dissipation module 20. Other components may be present, such as a fan (not shown) to improve airflow. A fan may be solar powered or powered by power supply 16.

Referring to FIGS. 2 and 7, rear base portion 62 may have a suitable structure. Portion 62 may define a receptacle that receives axial ends 58D of side rod portions 58, as well as part of baffle plate 22. The portion 62 may mount under and support rear base portion 62 to enclose axial ends 58D of side rod portions 58. Referring to FIG. 2, fins 62B may be provided in portion 62 to provide a heat sink for the housing 12, for example for the compartment 62M. Holes may be provided to mount portion 62 to portion 60, for example via fasteners. Referring to FIG. 7 portion 62 may be formed by side walls 62G, a base wall 62H, and wiring conduit and pole adaptor 62D. Portion 62 may mount portion 60 by a suitable method, for example using hinges 68.

Referring to FIGS. 1, 2, and 7, a rear mount, such as adaptor 62D, may be provided to connect the luminaire 10 to a mast, for example a cantilever arm 76 (FIG. 18) of a mast 74. Adaptor 62D include holes 62F for receiving fasteners such as bolts 66 to grip and secure the luminaire 10 to a mast in use. The rear mount or portion 62 may form an adaptor of a series of adaptors that are interchangeably attached to housing 12 and that each fit a different size or shape of mast, to permit ease of field adaptation and installation of luminaire 10 to various sizes and shapes of masts in use. The rear of the housing may include the mounting adaptor 62D. The interface between the adapter and the housing may be modular, such that the same housing will accept multiple different adapters to attach to different poles as required without the need for retooling the production line, and may be changed in the field as required.

Referring to FIG. 3, a mount 12J may be provided for a photosensor 43 (FIG. 19). A photosensor 43 may be coupled to the luminaire controller to provide feedback on ambient light levels in order to initiate (for example at dusk), deactivate (for example at dawn), or modulate (for example during cloudy or sunny periods) the light produced by the luminaire 10. The housing 12 may have prewired connection or strip to an ANSI C136.41 photocell socket, and provision for punchouts for alternative photocell or control packages. The photocell may include a smart controller.

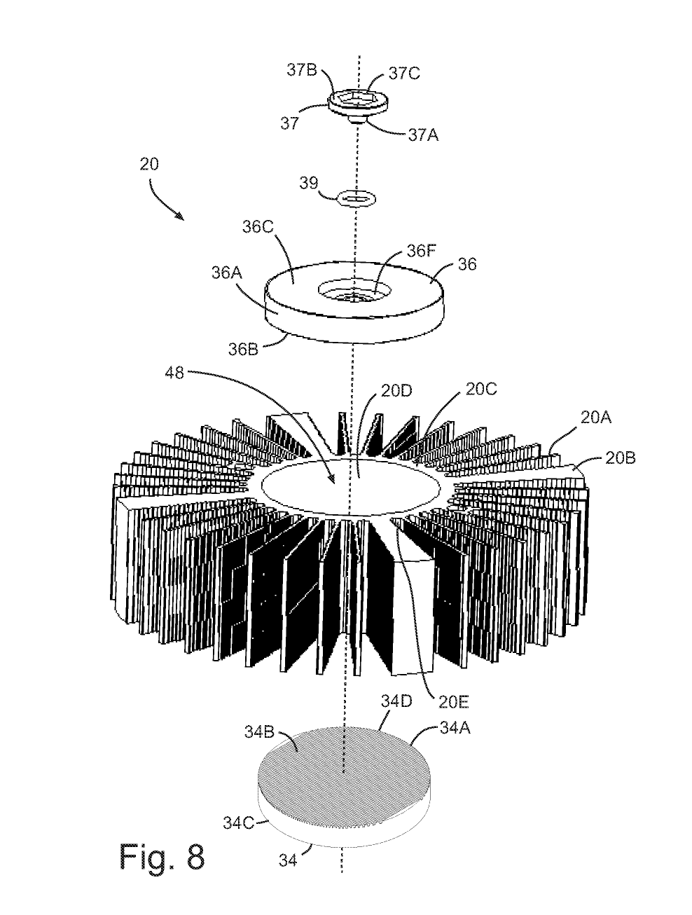

Referring to FIGS. 8, 11, and 15, a heat dissipation module 20 is illustrated. The module 20 may comprise a housing, such as is formed by encircling side wall 20C and end walls 34 and 36. End wall 34 may form a base, and end wall 36 may form a top of the housing. The walls 20C, 34, and 36 may collectively define an internal chamber 48. Referring to FIG. 8, a plurality of fins, such as radial fins 20A and 20B, may be arranged about the housing, for example arranged about an external surface 20E of encircling or cylindrical side wall 20C.

Referring to FIG. 10, radial fins 20A may be structured to promote heat dissipation to ambient air. Fins 20A may project from an external surface 20E of side wall 20C (FIG. 8). Fins 20A may achieve a heat sink function. A heat sink is a passive heat exchanger that transfers the heat generated by an electronic or a mechanical device to a fluid medium, often air or a liquid coolant, where it is dissipated away from the device, thereby allowing regulation of the device's temperature at optimal levels. In computers, heat sinks are used to cool central processing units or graphics processors. Heat sinks are used with high-power semiconductor devices such as power transistors and optoelectronics such as lasers and light emitting diodes (LEDs), where the heat dissipation ability of the component itself is insufficient to moderate its temperature. A heat sink is designed to maximize its surface area in contact with the cooling medium surrounding it, such as the air. Air velocity, choice of material, protrusion design and surface treatment are factors that affect the performance of a heat sink. Heat sink attachment methods and thermal interface materials also affect the die temperature of the integrated circuit. Thermal adhesive or thermal grease improve the heat sink's performance by filling air gaps between the heat sink and the heat spreader on the device. A heat sink may be made of a suitable material, for example copper and/or aluminum. Copper is often used because it has many desirable properties for thermally efficient and durable heat exchangers. Copper is an excellent conductor of heat, and has a relatively high thermal conductivity that allows heat to pass through it quickly. Aluminum is used in applications where weight is a big concern.

Referring to FIG. 10, in the example shown fins 20A are thin plate structures. Side walls 20A-1 20A-2 of fins 20A may be textured or otherwise structured to increase the total surface area of the fin 20A, and hence the module 20. As shown, walls 20A-1 and 20A-2 may be stepped with each step having a corresponding tread 20A-4 and rise 20A-5. The stepped configuration of one wall 20A-1 may be staggered relative to the stepped configuration of the opposed wall 20A-2, to avoid or minimize thin sections between adjacent treads 20A-4. By providing fins 20A and by furthering adjusting the surface topography of the fins 20A, increased surface is produced that facilitates air cooling of the module 20. In some cases, ridging of the metal may result in folding, and increased surface area of 5-10 times. Referring to FIG. 9, radial fins 20B may, by contrast with heat dissipating fins 20A, be relatively thicker to permit mounting of module 20 to structural components of the luminaire 10. Each fin 20A may be elongated in a T structure (not shown) in cross section. Each step may have suitable dimensions, for example, the thickness of the step may be 1-2 mm, the cross-sectional shape of the step may be semicircular, triangular, rectangular or another suitable shape, in some cases 0.1-1.8 mm in length.

Referring to FIGS. 8, 11, and 15, a plurality of grooves 34A may be defined in an interior surface 34B of wall 34. Referring to FIGS. 8, 12, and 13, the grooves 34A may take an appropriate shape. For example, each of the plurality of grooves 34A may be straight and run between opposed perimeter edges or edge 34D of the base wall 34. Straight grooves 34A may be machined, and may have a constant cross-sectional shape travelling down an axis of each groove 34A. Other shapes of grooves 34A may be used, including curved, bent, or curved and bent axis grooves 34A.

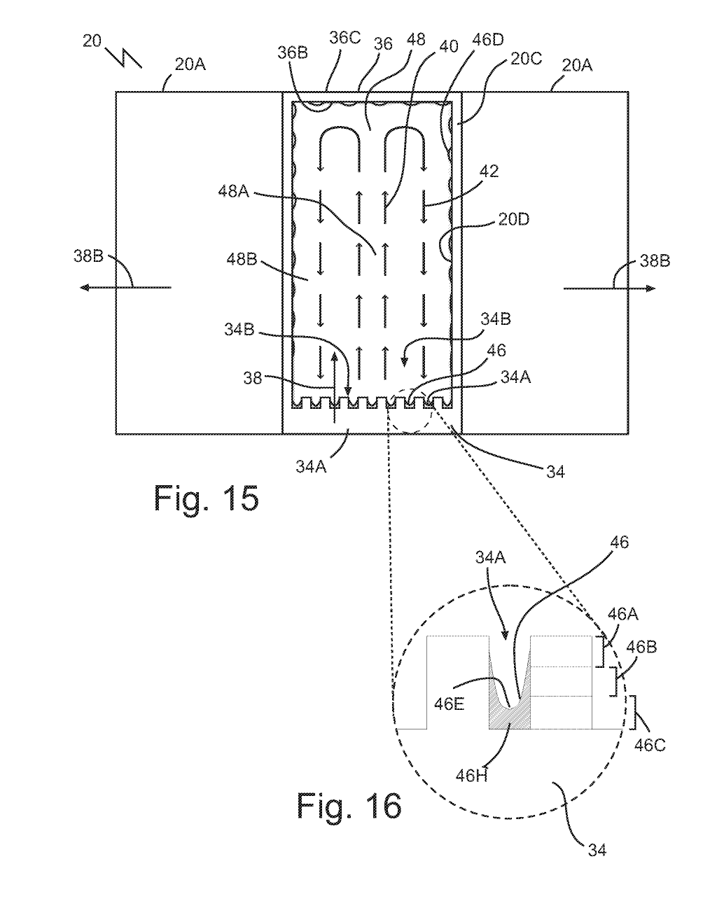

Referring to FIGS. 15 and 16, the grooves 34A may cooperate in use with a heat transfer fluid 46 to facilitate heat transfer and dissipation. The heat transfer fluid 46 may be positioned within the internal chamber 48, which may be sealed to prevent loss of fluid 46 over time. The heat transfer fluid 46 may be provided in a quantity, and selected to have a boiling point, sufficient to provide the heat dissipation module 20 with an operating range of heat flux applicable to a particular heat source. Each module 20 will be tuned for a particular operating range that corresponds with the heat flux produced by the connected heat source, in the example shown LED module 14. When the luminaire 10 is within steady state operation, and the LED module 14 is producing a constant heat flux through the base wall 34 into the internal chamber 48 and out the fins 20A, the heat transfer fluid 46 may cycle between liquid and gas states, with both states present within chamber 48. Base wall 34 may form a thermally conductive thin plate to facilitate heat transfer, the thin plate having a planar heat-receiving external surface, such as wall 34C. The module 20, or any part of it, may be made of a suitable material such as aluminum. Thus, under normal operation heat will be drawn from the heat source into the bottom of the chamber 48, and from there into the liquid. The liquid will rise in temperature until it hits its boiling point and begin to boil. Subsequently the primary mode of heat extraction may be through the latent heat of vaporization of the fluid.

Referring to FIGS. 15 and 16, fluid 46 may, within the operating range of heat flux, cycle between a gas phase where liquefied heat transfer fluid 46 (FIG. 16) boils within and is expelled from the plurality of grooves 34A, for example in a direction 40 up a central portion 48A of chamber 48. The fluid 46 may cycle into a liquid phase, such as shown by droplets 46D, where gaseous heat transfer fluid 46 condenses and drains back into the plurality of grooves 34A down an annular portion 48B of chamber 48, along lines 42. By transfer heat by evaporation and condensation, the module 20 takes advantage of the relatively large latent heat of vaporization of fluid 46, and the gas-liquid phase change of said liquid heat transfer medium in said plurality of grooves is used for heat dissipation. During this process heat moves along lines 38A into chamber 48 and fluid 46, and out of module 20 and luminaire 10 via lines 38B through fins 20A. The amount of fluid 46 may be selected such that during steady state operation within the operating range of heat flux, the fluid 46 may continually enter the grooves 34A without immersing the interior surface 34B of base wall 34. While operating within the operating range of heat flux, respective temperatures of the top wall and base may be within a relatively narrow range, such as within 5° C., for example within 3° C.

The plurality of grooves 34A may be used to form a micro-scale composite phase change enhanced heat transfer process to significantly increase the phase change heat transfer coefficient and heat transfer heat flux density when compared to heat transfer to change temperature of the fluid 46. The conditions and intensity of the micro-scale phase transition heat transfer may be closely related to the geometrical shape and size of the groove. The heat transfer intensity may be at least two times less than that of a micro-scale composite phase change. When the geometries and dimensions of the grooves are within the range described above, a high intensity fine scale composite phase change heat transfer process including thin film evaporation and cell boiling may occur in the channel or groove 34A.

Referring to FIG. 16, the plurality of grooves 34A may be sized, and the heat transfer fluid 46 may be selected, such that within the operating range of heat flux the heat transfer fluid 46 forms a concave meniscus within each groove 34A. The meniscus is the curve in the upper surface of a liquid close to the surface of the container or another object, caused by surface tension. A meniscus may be either concave or convex, depending on the liquid and the surface. A concave meniscus occurs when the particles of the liquid are more strongly attracted to the container (adhesion) than to each other (cohesion), causing the liquid to climb the walls of the container. This occurs between water and glass. Water-based fluids like sap, honey, and milk also have a concave meniscus in glass or other wettable containers. Menisci are a manifestation of capillary action, by which surface adhesion pulls a liquid up to form a concave meniscus or internal cohesion pulls the liquid down to form a convex meniscus. The plurality of grooves 34A may be sized, and the heat transfer fluid 46 may be selected, such that within the operating range of heat flux, when viewing the plurality of grooves in cross-section (FIG. 16), a maximum height 46C to a minimum height upper surface 46E of a base of the meniscus is less than half, for example equal to or less than ⅓, of the total height (being the combination of heights of sections 46A, 46B, and 46C) of the heat transfer fluid 46 within the groove 34A. The sections 46A-C may delineate a base section 46H, a thin film evaporation section 46B, and an absorption section 46A. The meniscus, and adhesive forces between fluid 46 and base wall 34, may stretch the fluid 46 out into a thin film, reducing the energy required to evaporate or boil the fluid 46.

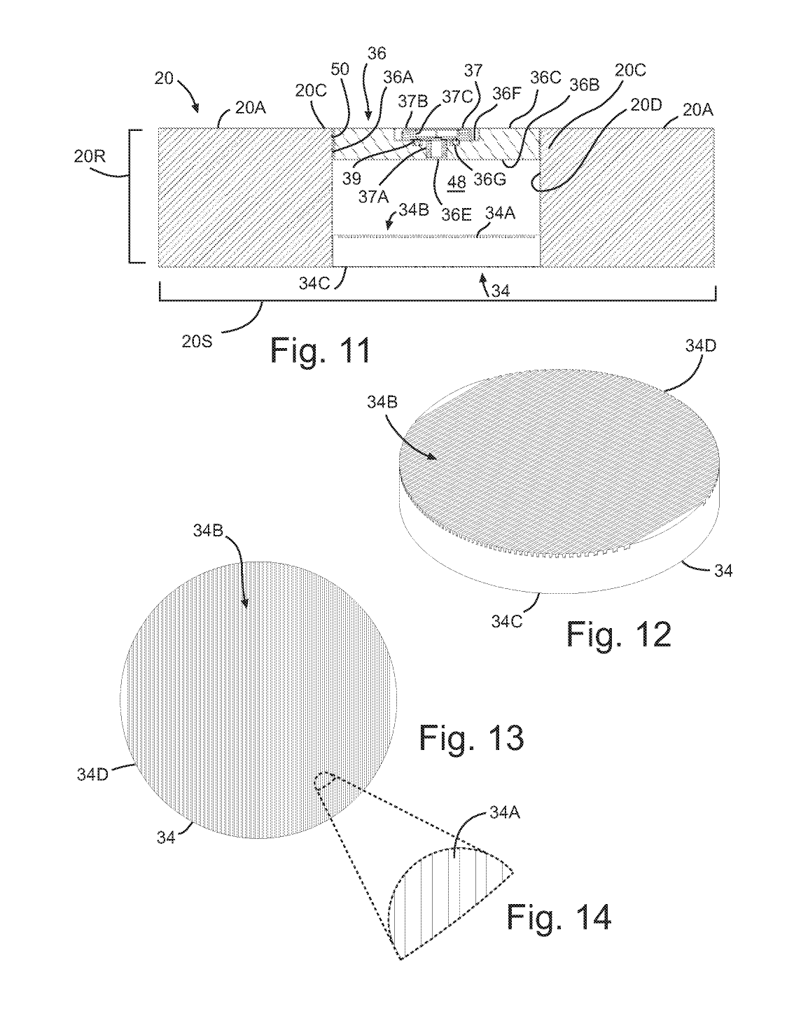

Referring to FIGS. 11-16, the heat transfer fluid 46 and grooves 34A may have suitable characteristics to cooperate. Each of the plurality of grooves 34A may have a cross-sectional shape with a width of 0.07 mm to 1.2 mm, for example 0.4 mm+−0.05 mm. Each of the plurality of grooves 34A may have a cross-sectional shape with a depth of 0.07 to 1.2 mm, for example 0.9+−0.05 mm. Each of the plurality of grooves 34A may have a cross-sectional shape with a channel pitch of 0.2 to 2 mm. Groove 34A to groove 34A separations may be made as closely as possible without compromising the structural integrity of the grooves 34A. Other shapes and dimensions may be used.

The grooves 34A may be made small enough that liquid fluid 46 that contacts the grooves 34A upon condensing may be drawn through the groove 34A by capillary action regardless of relative orientation of base wall 34 relative to a horizontal plane. The inherent capillary forces of the fluid may produce a thin film of organic fluid over the entire surface of the groove 34A, increasing the effective number of nucleation sites and so increasing the effective heat transfer coefficient and thereby heat transfer flux density. The boiling of the fluid ejects vapor and liquid fluid into the chamber. This movement of vapor may form a convective cycle in the chamber, drawing heated vapor and fluid towards the top, increasing the effective heat dissipation of the radial fins.

As the vapor rises to the top, it cools and condenses on the surface of the chamber, and drains back into the microgroove structures, resulting in the constant replenishment of liquid into the chambers to replace that lost to vaporisation. The fluid selected may have a low viscosity to improve the rate of flow into the grooves. An even spread of fluid between microgrooves may be enhanced by the transfer of fluid between grooves through boiling over and capillary forces between the metal of the microgroove structures and the fluid. The fluid may be selected with a balance of surface adhesion. Too high and the fluid may not readily flow into the microchambers, too low and the meniscus may be too small, and fluid will not spread evenly between grooves through boiling action.

The fluid may be kept at a relatively low temperature, which allows a high heat transfer efficiency and keeps the chip temperature and diode temperature low, increasing efficiency and extending the effective life of the lamp.

Referring to FIGS. 15 and 16, a suitable heat transfer fluid 46 may be selected. The heat transfer fluid 46 may comprise an organic fluid, for example that is liquid at room temperature. An organic compound is virtually any chemical compound that contains carbon, although a consensus definition remains elusive and likely arbitrary. Organic compounds are rare terrestrially, but of central importance because all known life is based on organic compounds. The most basic petrochemicals are considered the building blocks of organic chemistry. In some cases the organic fluid is hydrophobic in nature.

The organic fluid may comprise acetone, or an acetone derivative, such as a ketone. Acetone derivatives (or ketones) are an important class of industrial chemicals widely used as solvents and as chemical intermediates. They are known for being strong, versatile organic solvents and, therefore, are essential components of many consumer and commercial products. Ketones are used safely and effectively in everyday products such as paints, adhesives, printing inks and cleaners. They are used extensively in the coatings industry as solvents for nitrocellulose and other cellulose esters and for vinyl chloride-vinyl acetate and other resins. They are used as active solvents or diluents, often, in combination with other solvents. Their low densities, combined with strong solvency, make them desirable solvents for meeting Volatile Organic Compound regulations. Ketones are also used extensively in the manufacture of commercial products such as pharmaceuticals, plastics, fibers and films. Other types of organic fluids may be used, such as alcohols, particularly for warmer climates.

Referring to FIGS. 15 and 16, the fluid 46 may be selected to have a suitable boiling point. Because the temperature of the chip set is determined by the boiling point of the fluid, selecting an appropriate boiling point may make a difference in performance. Selecting a low boiling point will reduce the temperature of the chipset, extending the working life of the chip, and increasing the acceptable power density of the heat source. However if the boiling point of the fluid is set too low the radiator fins will not remove heat from the chamber quickly enough when ambient temperatures are high, resulting in full vaporization of the fluid. A fully vaporized fluid will be reduced to transporting heat only by convection between the air in the chamber and the microgrooves, dramatically reducing the effective transport of heat away from the chipset, particularly given the relatively insulative effect of a gas over a liquid of the same chemical makeup. Full vaporization may cause a large temperature rise of the chipset, and thermal damage.

The boiling point may be carefully selected with regards to expected ambient temperatures in the target market. For a northern climate with a maximum of 40° C. ambient a boiling point of 64° C. may be selected to in practice will keep the chip below 80° C., while maintaining enough of a junction temperature difference on the radiator fins to maintain exchange performance. In some cases the boiling point of the heat transfer fluid 46 is between 40 and 65° C. and in some cases above or below this range. In some cases the boiling point of the heat transfer fluid is below 50° C. Common ketone examples include acetone, which boils at 50° C., benzophenone, which boils at 48° C., 4-bromoacetophenone, which boils at 51° C., 2-acetylnaphthalene, which boils at 53° C., and 1,3-Diphenyl-2-propen-1-one (benzalacetophenone), which boils at 58° C. Fluid 46 may be selected to have greater adhesive forces with the materials of the base wall 34 than cohesive forces amongst like particles, to ensure a concave meniscus formed in grooves 34A.

Referring to FIG. 11, the module 20 may have suitable characteristics to inject fluid 46 and to seal against fluid 46 losses. Top wall 36 may have a suitable structure, such as provided by a disc forming wall 36, and defining a structure that defines a heat transfer fluid injection port 36E. Referring to FIGS. 8 and 11, port 36E may be threaded to receive a correspondingly threaded bolt part 37A of a set screw 37 or other plug part. The screw 37 may define a tool aperture 37C, such as a hex aperture, to permit a tool (not shown) to install and secure the screw 37 in place. A flange 37B of screw 37 may overlie a recessed shelf surface 36F in an exterior face 36C of wall 36. A threaded connection 50 may secure a cylindrical side wall 36A of plate or wall 36 to an interior surface 20D of encircling side wall 20C of module 20. A suitable seal, such as gasket or o-ring 39 within gasket receptacle 36G of surface 36F may be used. The walls 34 and 36 or one of them may be welded in place to further prevent fluid 46 leakage. A nipple (not shown), such as a one-way nipple may be used in screw 37 to permit fluid 46 injection into chamber 48. Interior face 36B of wall 36 may face into the chamber 48. Referring to FIG. 11, an axial length 20R of module 20 may be shorter than, for example less than half, a width or diameter 20S of module 20, providing a disc shape as shown.

Referring to FIGS. 15 and 16, boiling point of fluid 46 may be adjusted by adjusting the pressure within the chamber 48, for example by reducing the pressure. In some cases oxygen may be evacuated from chamber 48, for example to avoid oxidizing the fluid 46. Because the fluid 46 may be present in relatively small, in some cases trace, quantities, a suitable seal may be formed to prevent long and short-term losses of fluid 46 to the environment.

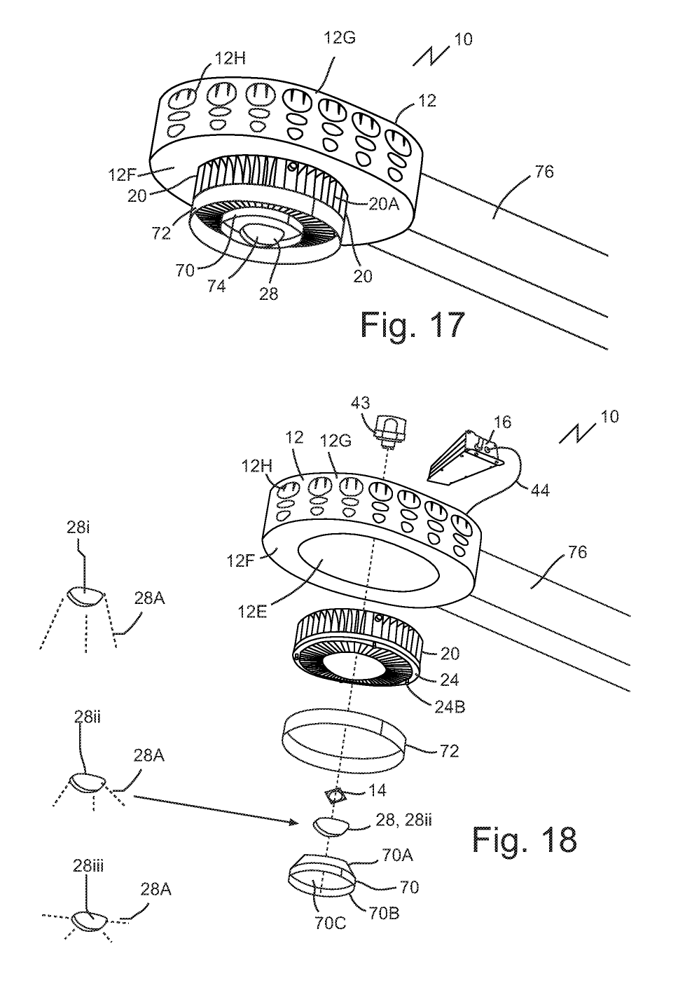

Referring to FIGS. 17-19, an apparatus is illustrated comprising a luminaire 10 at or near a top 74A of a mast 74. The apparatus may comprise mast 74, an LED (light emitting diode) module 14, such as provided by luminaire 10, and a power supply 16. Power supply 16 may be mounted at a suitable location along or near the mast 74, for example at or near a base end 74B of the mast 74. The luminaire 10 may be mounted on a cantilever arm 76, which extends from mast 74, as is common with streetlights. Wiring 44 may connect the LED module 14 and power supply 16. The mast 74 may be a suitable height, for example 10, 15, or more meters in height.

Referring to FIG. 19, the wiring 44 and power supply 16 may be mounted in a suitable fashion. The wiring 44 may extend through a hollow interior of the mast 74, so as to avoid or minimize exposure of wiring 44 to elements and animals. The power supply 16 may be mounted within the hollow interior as well in some cases. A side wall of the mast 74 may comprise an access door, such as a hand door 101, adjacent the power supply 16. Doors 101 are common on streetlight masts 74, and may be leveraged to mount power supply 16. In other cases the power supply 16 may be mounted external to the mast 74, for example the power supply 16 may be mounted within a compartment 99 mounted to an external side wall of the mast 74. The compartment 99 shown has a box 99A and a door 99B to protect the power supply 16.

Referring to FIG. 19, the power supply 16 may be mounted at a suitable point along the mast 74. In some cases the power supply 16 may be mounted above a ground surface 103, for example at a height 108 of at least 3 m and in some cases 10 m or more above the ground. The power supply 16 may be mounted below a height 110 of the luminaire 10 (for example less than half of the height 110) but within ladder access distance from the ground surface 103, to improve ease of access to the power supply 16 whilst still protecting the supply 16. In some cases the power supply 16 is mounted adjacent the ground surface 103. The power supply 16 assembly may include a dimmable LED driver, which may be mounted either in the housing assembly or remotely, for example up to 15 m, 50 m or more away from the luminaire 10. In some cases separate power supplies may be mounted in the housing 12 and down the pole, for example in a passively switched fully redundant configuration, with one or both supplies operating as a backup power supply.

Remote placement of power supply 16, allows installation inside the hand hole or mounted in a box on the side of the pole to allow for easy access for maintenance, or both in the housing assembly and down the pole in a passively switched fully redundant configuration as a backup power supply. At the current time, LED street lighting provides the power supply in the housing of the luminaire 10 itself. Because the power supply generally has a shorter lifespan than the LED chip, it is common to replace the power supply before replacing the entire head. While the industry has made some progress towards minimizing the cost and labour associated with changing a power supply through toolless entry and other innovations, such entry still requires access to the head itself, requiring significant time and money in order to transport and set up aerial lifts. As a result of remotely locating the power supply 16 relative to the luminaire 10, the power supply can be inspected and serviced or replaced as necessary without the use of aerial lifts, reducing the time and cost while increasing worker safety.

Referring to FIGS. 6 and 17, different arrangements of the heat dissipation module 20 and housing 12 may be used. Referring to FIG. 6, the module 20 may be fully inset within the housing 12. Referring to FIGS. 1-3, venting such as one or more of vents 52A in top access panel 52, and air gaps or vents 29 defined between collar cap 24 and lens gland 26, may be used to provide air flow to heat dissipation module 20. In the example shown such vents access interior 12E to define an internal air conduit that permits air to flow into housing 12 across fins 20A, and out of housing 12 to dissipate heat. Referring to FIG. 17, vents 12H may be provided in an encircling side wall 12G of housing 12, for example with vents 12H arranged about at least partially around a periphery of wall 12Q. In some cases vents are sized to prevent ingress of small animals, including birds and rodents or squirrels. Vents include air gaps, holes, cutouts, slots, and other structures designed to permit air flow. Referring to FIGS. 4 and 17, heat dissipation module 20 may have a suitable orientation relative to housing 12, for example enclosed within housing 12 (FIG. 4) or partially inset, for further example with fins 20A depending at least partly below, housing 12, for example flange 12F of housing 12 (FIG. 17). Vents in housing 12 may permit air flow in an interior 12E that is isolated from sealed power supply compartment 62M. The housing 12 may provide a consistent airgap between the radiator and the housing wall to allow for proper air flow through the radiator fins, except at the back. Venting may be in a hived shape, on the sides or top of the head to allow for ventilation through the radiator. Vents may be provided in one or more of the other portions of the housing 12, such as portions 56, 58, 60, and 62.

Referring to FIGS. 20 and 21, a luminaire 10 with an SMD module 14 is illustrated. Under current practice the industry uses SMD technology for high power applications such as high mast street lighting or stadium lighting. High mast lights include lights that are supported at heights of 75 feet or higher above the ground, whereas streetlights include lights that are supported at heights of less than 75 feet above the ground. Such lights may have a single head, double head, or in the cases of high mast lights, may have more than two heads, such as 8-9 heads.

SMDs generate the required overall luminous flux by placing several discrete LEDs over a large surface, which facilitates cooling. Because the LEDs are separated by relatively large distances in an SMD module, it may be difficult to appropriately mold the light into desirable distribution patterns. Referring to FIGS. 20 and 21, typical solutions involve either recessing the light emitting module 14 and using a lens 28, which may result in light wasted inside the fixture (for example over area 82), may create high weight fixtures, may require cut-off fins or shields 72, which again results in light wastage, or may require that the individual diodes 78 be placed to generate a set pattern, which results in a coarse distribution pattern and a patchy non-continuous light pattern. The modules 14 used in the disclosures here may be COB, SMD, or other. However, in some embodiments a COB module 14 is used.

Referring to FIG. 22, a COB LED by contrast with an SMD LED allows a significantly increased luminous flux density by packing several diodes 14C together very closely onto a single PCB (printed circuit board) 14A, resulting in a much smaller light emitting surface and significantly easier light shaping. In the example shown the array of LEDs has a length and width of 235 mm, with each individual diode 14C having a diameter of 25 mm. Referring to FIGS. 17 and 18, lenses 28 used to shape light emitted from a COB may be relatively smaller and lower weight than for a comparable light producing SMD LED, and the cutoff fins or shields 72 may be much smaller reducing the weight and wasted light. Because the light emitting surface is significantly closer to an ideal point source, and all the lights are contiguous, the control achieved with COB-suitable lenses is significantly higher, and a larger variety of different lenses may be used to achieve a greater variety of different light different distributions than is possible with an otherwise identical SMD head. Referring to FIG. 18, because the COB LED module 14 may act as a near point source, it may be possible to provide significant secondary shaping utilizing reflector shields 70. A reflector shield 70 may comprise a conical or curved section 70A with or without a terminal collar 70B, and the interior surfaces 70C of the shield 70 may be coated with or otherwise provide a reflective surface. SMD heads, because of the widely dispersed SMD chips, generally only use lenses for shaping, as the wide and discontinuous spread of such light sources makes reflected light patchy and results in significant ghosting. The proposed COB model may allow a variety of light distribution patterns, including custom distribution patterns, using the same LED module 14, radiator (module 20), power supply 16 and housing 12 assembly. As a result, all heads may be constructed on a single production line with zero retooling, and allowing field adjustment of the distribution category.

Referring to FIG. 18, a luminaire 10 may include a plurality of lenses, such as lenses 28i, 28ii, and 28iii, with each lens being structured to interchangeably mount to the housing 12 to shape light emitted from the COB LED module 14. Each lens 28 may be constructed to shape light emitted into a respective light beam 28A that is different from the respective light beams 28A produced by the other lenses 28 of the plurality of lenses 28. For example, each lens 28 may produce a respective light beam 28A that has a different beam angle, such as a 30 degree (top lens 28i), 60 degree, 90 degree (middle lens 28i), 120 degree, 180 degree (bottom lens 28ii), or other suitable beam angle, than other lenses of the plurality of lenses. Each lens 28 may also magnify light to produce a respective light beam that has a different light focus distance, such as 20, 25, 40, 50, 75, 100 feet, or other distances, than other lenses of the plurality of lenses. Referring to FIG. 19, the light focus distance may be understood as the ideal separation distance between lens 28 and ground 103 for a particular lens 28, such that above or below such distance the light pattern becomes relatively less clear, patchy, or distorted.

Referring to FIG. 18, each lens 28 may also produce a respective light beam 28A that has a different light pattern, such as forming light in a rectangular, square, triangle, circle, or other suitable shape of light when projected on a planar surface, namely the ground surface in use. The COB LED module 14 may be structured to produce light of a color temperature with a range of color temperatures from about 1800 to 2200 K. Such relatively low temperature light may have an amber or yellowish color, for example of the same color as traditional metal halide streetlights, and such color may be beneficial as such is associated with fewer health problems than white light. For example, amber or yellow light may carry fewer long term exposure negative health effects, such as damage to eyes, cataracts, epilepsy, shadowing, and starbursting, as well as providing fewer short term negative effects such as by having better visibility during fog and night time.

In the field, an interchangeable system permits a user to customize a particular luminaire 10 in the field to fit a particular installation. For example a user may determine the height of the luminaire 10, and the area that the user desires to light up, for example a roadway and adjacent walkway, or just a roadway. Next, the user may select a lens 28 that will provide a suitable pattern, focal distance, and beam angle, to achieve the desired output light beam. In some cases the lens may have a different target axis to permit light to be directed other than directly downward, and in other cases the angular position of the lens may be adjusted to direct light other than directly downward. Next the luminaire 10 is mounted on the mast with the selected lens. The lens may itself be mounted before or after the luminaire is mounted. Such a method permits a relatively lower power LED light, such as a 50 W light, to be modified to produce a light beam that is comparable to that produced by a conventional 100-150 W LED light or a 400-500 W metal halide light. Permitting customizability at the field or planning level may require that a user carry a relatively larger stocks of lenses 28 than luminaires 10, however, such lenses may be substantially cheaper than, for example 1/10 the price of, the luminaire 10, leading to cost savings from avoiding the situations where a) extra luminaires are required to provide the most appropriate luminaires in the field, and b) fewer luminaires need be kept in stock as such can be customized in the field. Also, interchangeability places less pressure on the installer to install less-than-ideal luminaire for a given situation. Other parts of the luminaire 10 may be interchangeable, such as the cutoff shield 72, an LED controller (not shown), and the reflector 70.

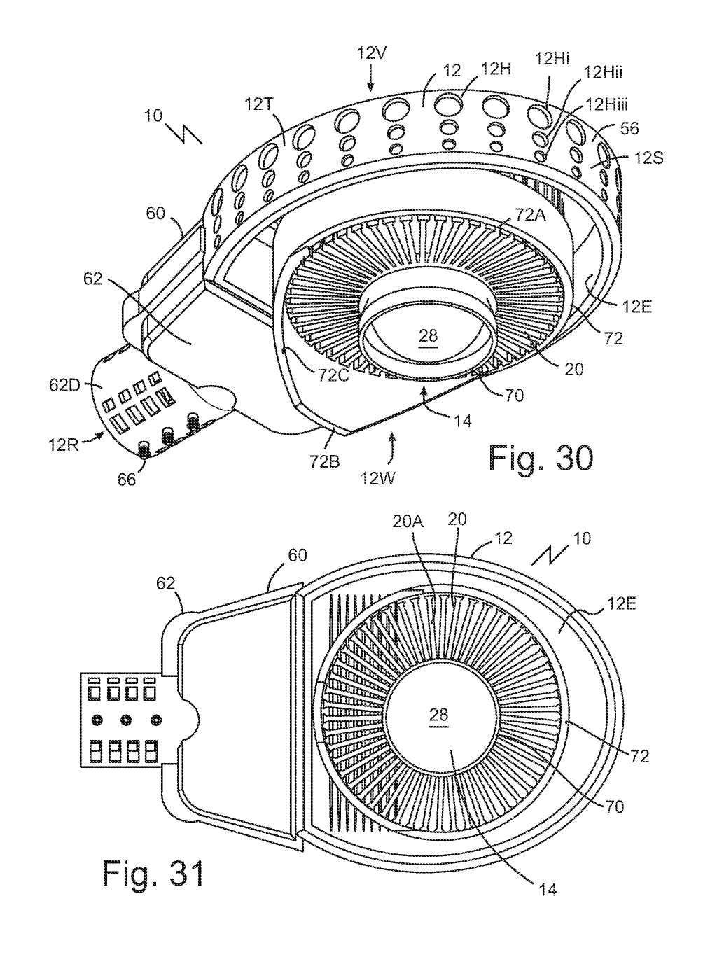

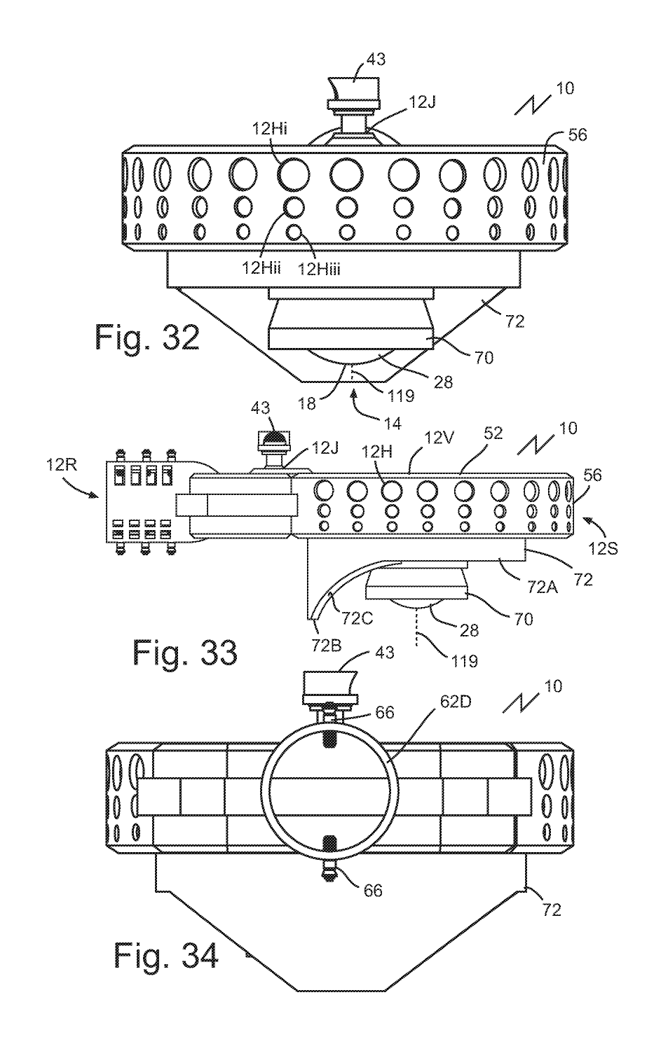

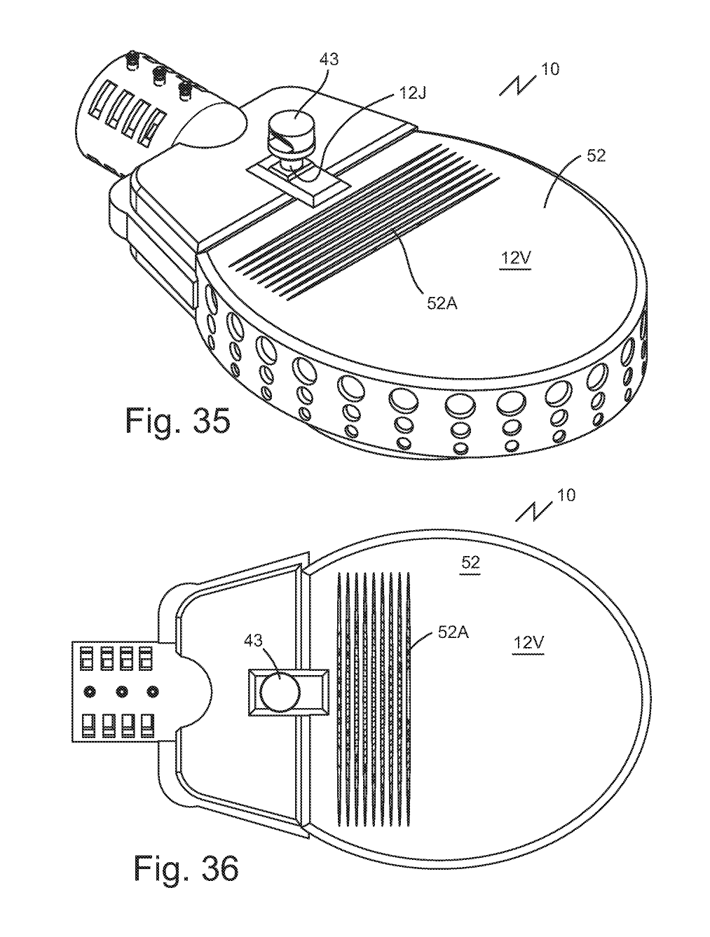

Referring to FIGS. 30-38, a further embodiment of a luminaire 10 is illustrated. The luminaire 10 is a variation of the luminaire 10 of FIG. 1 and illustrates the use of interchangeable lenses 28, reflector shields 70, and cutoff shields 72. Referring to FIGS. 30 and 31, a base end 12W of the housing 12 may be open, to increase exposure to air flow of heat dissipation module 20, which may be inset within the interior 12E defined by housing 12. Referring to FIGS. 30, 32, and 33, vents 12H may wrap at least partially around an arcuate side wall 12T of housing 12, for example from front end 12S toward rear end 12R, with wall 12T formed on tip portion 56. Vents 12H of different sizes may be provided in rows of vents 12H. For example, in the direction from top end 12V to base end 12W of housing 12, rows of vents 12Hi, 12Hii, and 12Hiii are located in sequence from larger to smaller cross-sectional vent areas. Referring to FIGS. 32-36, top end 12V may locate a mount 12J for photosensor 43. Access panel 52 may be located within and held by side wall 12T of tip portion 56. Panel 52 may be configured for toolless entry, for example by a hinge, latch, or other locating system (not shown).

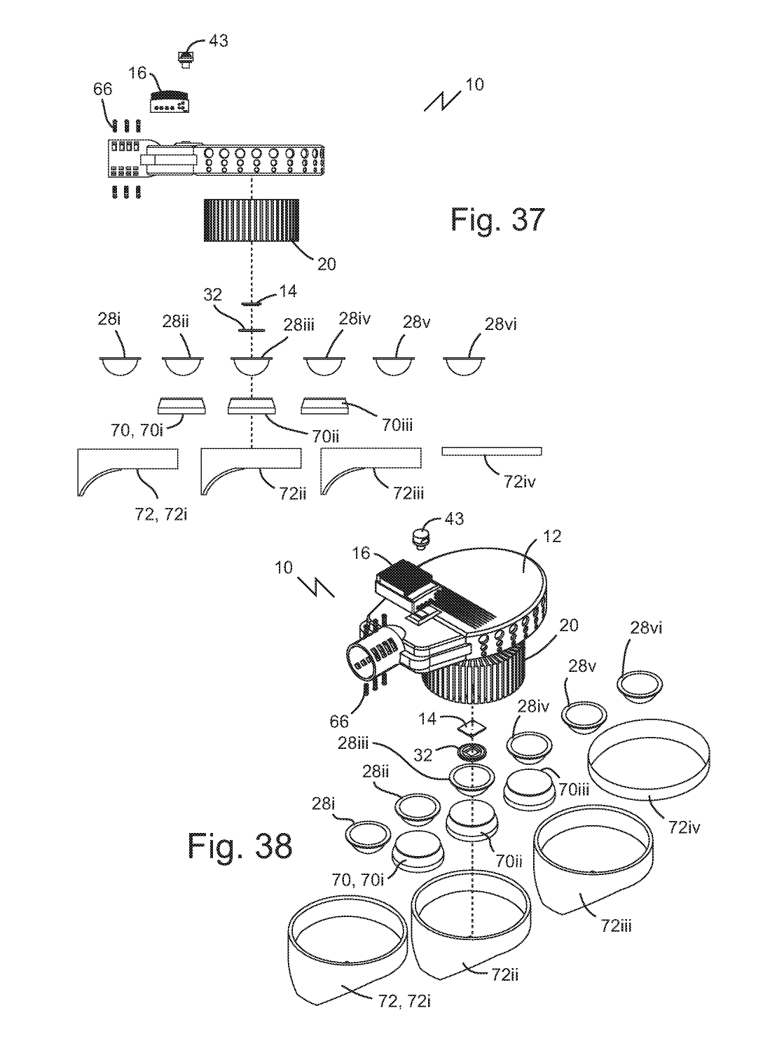

Luminaire 10 may be provided as part of a customizable system of interchangeable parts. Referring to FIGS. 30, 32, and 34, cutoff shield 72 may have a suitable structure. For example, the shield 72 may have a cylindrical portion 72A and an extended shielding portion 72B. In the example shown a curved and/or straight transition portion 72C connects portions 72A and 72B. In use the position of shield 72 may be angularly adjusted about lighting axis 119 to target the extended shielding portion 72B toward a desired angular direction, such as may locate a residential zone if such were desired to be shielded from light produced by luminaire 10. In the example shown the extended shielding portion 72B is oriented toward a rear end 12R of housing 12, thus reducing or removing backlight otherwise produced by luminaire 10. Referring to FIGS. 37 and 38, plural shields 72 may be provided for interchangeability, such that a user may select an appropriate shield 72i or 72ii in the field to structure the luminaire 10 as desired. Various interchangeable reflector shields, such as shields 70i, 70ii, and 70iii, may also be provided with varying characteristics for customizability.

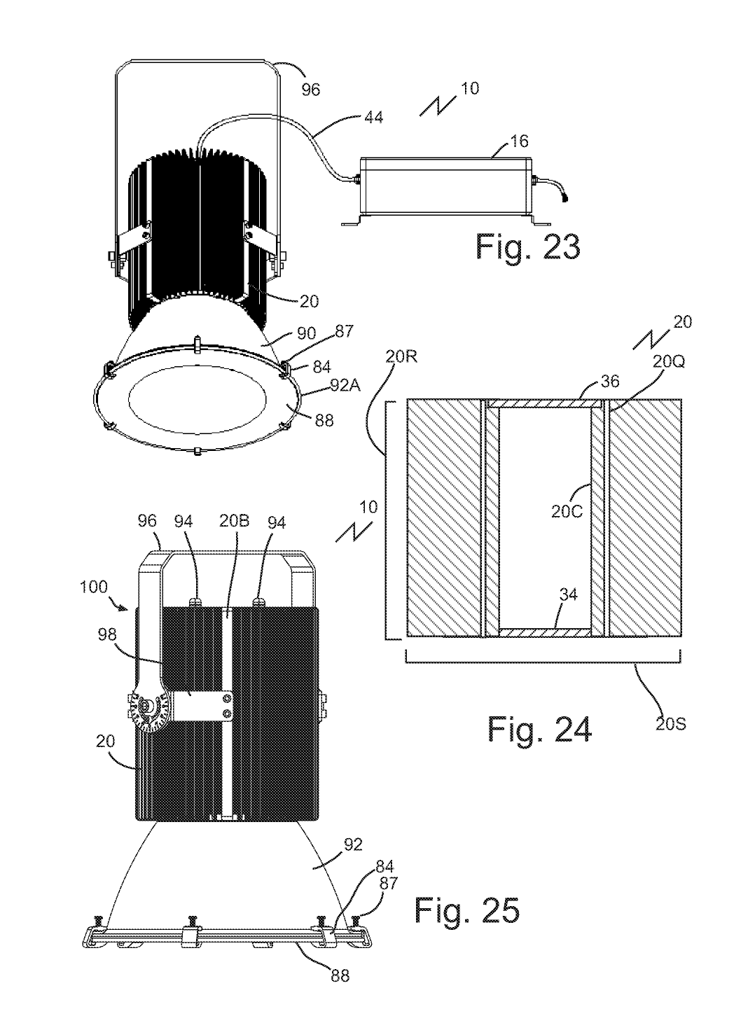

Referring to FIGS. 23-29, a further embodiment of a luminaire 10 is illustrated, forming a stadium light. A goal of stadium lighting design may be to provide lighting at any time of day that is equivalent to inside lighting, to provide ample lighting for competitive sports and events to occur on a stadium playing surface such as a football field. Live game lighting is functional, high-tech, and difficult to design. To meet the requirements of various sports competitions may require a light that is sufficient to facilitate the highest technical levels of athletic performance, correct assessment by the referee, and visual experience for the audience watching the sporting event. Stadium lighting may have multi-functional requirements in addition to meeting the requirements of sports competitions, and may also be required to meet the requirements for concerts, shows, rallies and various entertainment events, even if such occur at night during minimal or zero levels of ambient sunlight.

Many such events are televised. In order to ensure that the broadcast image is vivid and clear, with realistic colors, and to meet specific requirements such as vertical lighting, lighting uniformity and three-dimensional sense, demands may be placed upon the color temperature and color of the light source. In the field of sports lighting, the typical solution is to use 1000 to 2000 W high-power metal halide lamps, which are inefficient and energy wasteful. At present, market-standard sports field lamps use traditional aluminum radiators with low thermal efficiency, which may be a limiting factor to high power, high brightness special applications due to associated heat control problems. With LED chip power and integration improving, LED chip cooling problems become more and more serious, as above. The light source mounting surface size may often be fixed with conventional lamps, that is, only the original size and shape of the light source are suitable after the initial installation. Such may be the result of limitations inherently placed on the lamp by existing stadium lighting using integrated radiator and light source molding. If an operator wishes to install a light source with the same power but of a different size, the operator may be required to re-design the size of the radiator die. Otherwise, after the installation of the light source, the light source substrate and the radiator heating surface contact may be poor, forming a large contact heat resistance and negatively affecting heat transfer and dissipation. A forging process may be used to ameliorate such issues, but may only be used for low power ranges, at high cost.

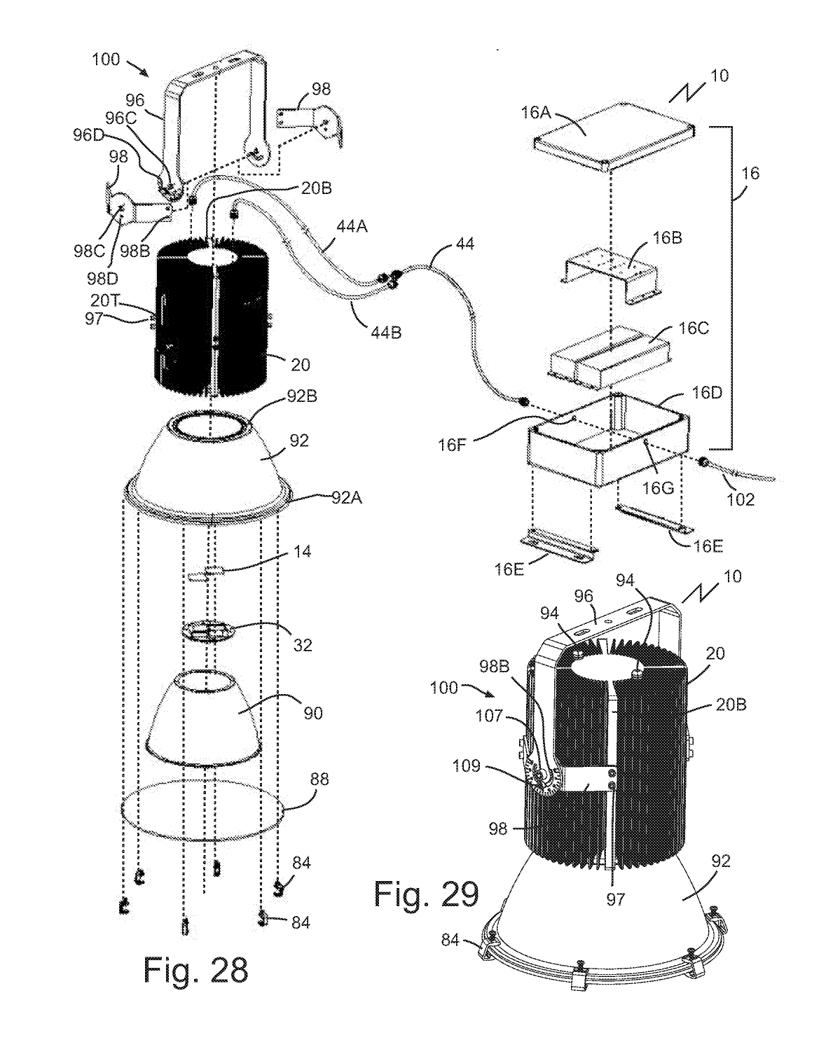

Referring to FIG. 28 an exploded view of the stadium light luminaire 10 is illustrated. The luminaire 10 may comprise a power supply 16 and a lighting unit. The lighting unit may comprise, in order from base to top, one or more of a glass pane 88, a reflective cup 90, an LED bracket 32, an LED module 14, a lamp cover 92, a heat dissipation module 20, and an angle adjustment system 100.

Referring to FIGS. 23, 26, and 28, the transparent cover, such as pane 88, may have suitable characteristics. The pane 88 may be constructed of a suitable material, such as glass or transparent plastic, and may be mounted to the lamp cover 92 by a suitable fashion, such as using a plurality of clamps 84, with associated fasteners 87, angularly spaced from another about an outer rim 92A of the cover 92. The clamps 84 may be flexible or hinged to permit advancing of fasteners 87 to grip the pane 88 and cover 92 together. The glass pane 88 may be tempered glass.

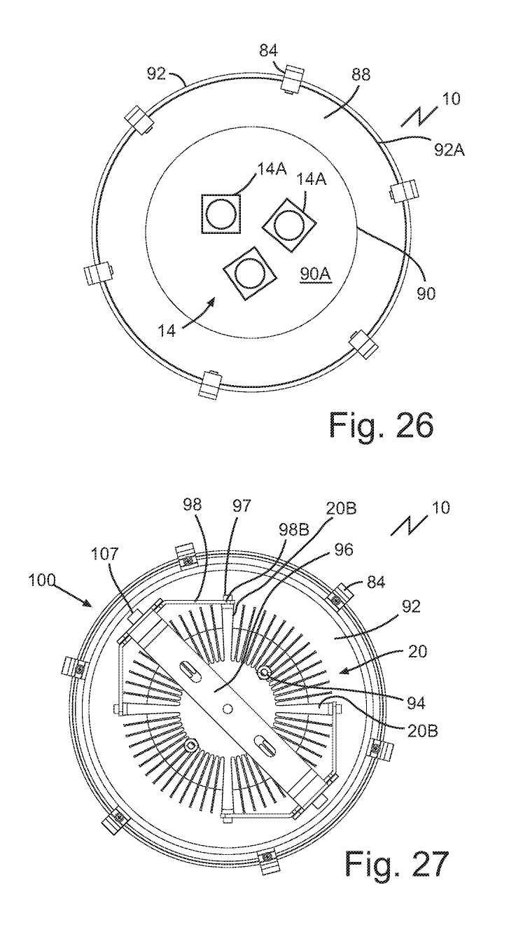

Referring to FIG. 26, cup 90 may have suitable characteristics. The interior surface 90A of cup 90 may have a reflective characteristic. Cup 90 may have a conical or curved conical shape as shown, or another suitable shape, which may increase in diameter when moving away from the LED module 14. The cup 90 may be selected to direct light in a selected pattern out of the luminaire 10.

Referring to FIGS. 26 and 28, the light module 14 and heat dissipation module 20 may be connected to cooperate in a suitable fashion. Similar to the embodiment of FIG. 1, the module 14 may connect directly to module 20, for example via fasteners (not shown) and bracket 32. Referring to FIG. 24, power to module 14 may be supplied through passages 20Q in side wall 20C (or fins 20B in other cases). An axial length 20R of module 20 may be longer than a width or diameter 20S of module 20. Referring to FIG. 26, several modules sets of COB PCBs 14A may be present.

Referring to FIG. 28, cover 92 may have suitable characteristics. The cover 92 may be secured to module 20 by a suitable fashion, such as by being sandwiched between bracket 32 and module 20. In other case fasteners (not shown) may pass through an inner flange 92B of cover 92 into module 20.

Referring to FIGS. 27, 28, and 29, angle adjustment system 100 may have suitable characteristics. System 100 may operate to fix the angle of luminaire 10 relative to a support surface (not shown), such as a mast, wall, or other surface. Referring to FIGS. 28-29, system 100 may comprise a bracket 96 and a pair of bracket holder arms 98. Arms 98 may mount to opposed sides of housing 12 (if present) or to module 20, for example by passing fasteners 97 through holes 98B in arm 98 and into holes 20T in structural fins 20B of module 20, with holes 20T aligned with holes 98B. Each arm 98 may have holes 98C and an arcuate slot 98D for passing hinge fastener 107 and locking fastener 109, respectively, into holes 96C and 96D, respectively of bracket 96, with holes 96C and 96D aligning with holes 98C and 98D, respectively. Other components may be present such as a spring or lock washer, and a regular washer, for example to facilitate secure fixing of fastener 109 in place. To set the angular position of the luminaire 10 relative to bracket 96, the user may loosen the positioning fastener 109, and rotate the luminaire relative to the bracket 96 about an axis defined by pins or fasteners 107, which slides the pin or fastener 109 about arcuate slot or hole 98B. Once in the desired angular position, the fastener 109 may be tightened to lock the luminaire 10 in position. In the example shown the system 100 may permit angular adjustments from 75 degrees down to 75 degrees up from horizontal.

Referring to FIG. 29, the power supply 16 is illustrated as having suitable components. In the example shown a housing is provided, for example made of a cover 16A and a corresponding box 16D. Box 16D may mount to a suitable support surface via a suitable mechanism, for example by mounting brackets 16E. Power entry and exit holes 16G and 16F may be provided in box 16D for appropriate wire connections to enter the box 16D. A supply wire 102 may connect into box 16D via hole 16G. Inside the box 16D may be various power regulator modules 16C, which may be secured to box 16D by a suitable method such as a bracket 16B. The power supply 16 may be mounted integrally or otherwise to luminaire 10, or may be mounted to a mast or other support structure independent of luminaire 10 such as is shown for another embodiment in FIG. 19.

In some cases the ultra-high power LED stadium lamp of the utility model has a plurality of small grooves on the scale, so as to realize the heat and heat of the gas-liquid compound transformation, which improves heat dissipation efficiency, keeps chip temperature and junction temperature low, leading to long device life. The heat dissipation assembly may be fabricated in combination with the light emitting module and enhances the suitability of the radiator and LED light source by placing the light source directly on the bottom surface of the radiator so that the heat sink can be connected to a variety of different types of LED light sources, greatly reducing processing costs. The cooling components and power supply components may be at a certain distance between the radiator with a special structure of cooling fins, through the above means to strengthen air convection, to further increase the cooling effect.

Referring to FIGS. 23 and 29, the power supply 16 may connect to supply power to the LED module 14 via a suitable mechanism. For example in FIG. 29 the wiring 44 running from the supply 16 may split into leads 44A and 44B, which then mount to corresponding connection points 94 on heat dissipation module 20, to permit power supply to module 14 through passages 20Q (FIG. 24). Referring to FIG. 23, wiring 44 may also be a single cable, which may contain two or more cables, that passes to module 14 via a suitable method.

In some cases the luminaire 10 has low BUG (backlight uplight glare) ratings. For example, luminaire 10 may produce no uplight. Luminaire may produce for example 3 or below for backlight, and 6 or below for glare. BUG ratings may be measured by drawing a sphere around a pole mounted light fixture with the light source in the center of the sphere. That sphere is then divided into three sections: Backlight, Uplight, and Glare (Forward light). Those three sections are then further divided into zones in which the lumen distribution is rated and given a value according to its environmental impact. Those values are used to standardize and identify which luminaire is right for a given application. Different applications require a different set of values.

In some cases the heat dissipating module 20 may be used for non-lighting applications, such as for cooling transformers, food, computer chips, and others. In some cases the module 20 may be used for heating applications, such as to thaw frozen food. Wiring includes rigid and flexible electrical conductors.

In some cases the luminaire 10 is a high mast light, for example with power of at least 500 W, for example 500-2000 W or higher. In some cases a streetlight is disclosed, with power of equal to or less than 100 W. In some cases a method is disclosed of replacing 3000-4000 watt lights with the above lower power LED lights. In some cases, such as high mast street and stadium lighting, color may be used at about 2700 K. For streetlights color of about 2200K may be used.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. An apparatus comprising:
a mast;
an LED (light emitting diode) module at or near a top of the mast;
a power supply at or near a base of the mast; and
wiring connecting the LED module and power supply.

2. The apparatus of claim 1 in which the power supply is 15 m or more away from the LED module.

3. The apparatus of claim 1 in which the apparatus is a streetlight or stadium light.

4. The apparatus of claim 1 in which the wiring extends through a hollow interior of the mast.

5. The apparatus of claim 4 in which the power supply is mounted:
within the hollow interior, with an access door positioned in a side wall of the mast adjacent the power supply; or
within a compartment mounted to an external side wall of the mast.

6. The apparatus of claim 1 in which the power supply is mounted at least 3 m above the ground surface.

7. The apparatus of claim 1 further comprising a second power supply mounted within a housing that mounts the LED module, in which the power supply and the second power supply are operated in a passive switching fully redundant configuration.

8. The apparatus of claim 1 in which the LED module is situated at least partially in a housing, and the housing comprises a plurality of mast adaptors each interchangeably connectable to a connection point on the housing, and each sized and shaped for a different size or shape of mast, with one of the plurality of mast adaptors connected to the connection point.

9. A heat dissipation module comprising:
a heat sink housing defining an internal chamber;
a plurality of heat sink fins arranged about the housing;
a plurality of grooves defined in an interior surface of a base of the heat sink housing within the internal chamber; and
a heat transfer fluid, within the internal chamber, the heat transfer fluid being provided in a quantity, and selected to have a boiling point, sufficient to provide the heat dissipation module with an operating range of heat flux, into the internal chamber across the base and out through the plurality of heat sink fins, within which the heat transfer fluid continuously cycles between a gas phase where liquefied heat transfer fluid boils within and is expelled from the plurality of grooves, and a liquid phase where gaseous heat transfer fluid condenses and drains into the plurality of grooves without immersing the internal surface of the base.

10. The heat dissipation module of claim 9 in which the plurality of grooves are sized, and the heat transfer fluid is selected, such that within the operating range of heat flux the heat transfer fluid forms a concave meniscus within the plurality of grooves.

11. The heat dissipation module of claim 9 in which the heat transfer fluid comprises an organic fluid that is liquid at room temperature.

12. The heat dissipation module of claim 11 in which the organic fluid comprises an acetone derivative.

13. The heat dissipation module of claim 9 in which:
the heat sink housing has an encircling side wall, the plurality of heat sink fins are radial fins arranged about an external surface of the encircling side wall, and the encircling side wall is cylindrical;
and the heat dissipation module is formed as a disc whose axial length is less than half of a maximum diameter of the heat dissipation module.

14. The heat dissipation module of claim 13 in which the internal chamber is defined by the base, the encircling side wall, and a top wall of the heat sink housing, and in which the top wall comprises a heat transfer fluid injection port.

15. The heat dissipation module of claim 14 in which, during operation within the operating range of heat flux, respective temperatures of the top wall and base are within 5 degrees Celsius of each other.

16. The heat dissipation module of claim 10 in which the boiling point of the heat transfer fluid is between 40 and 65 degrees Celsius.

17. The heat dissipation module of claim 10 in which each of the plurality of grooves is straight and runs between opposed perimeter edges of the base.

18. A luminaire comprising:
a housing;
a COB (chip on board) LED (light emitting diode) module;
a heat dissipation module; and
a plurality of lenses, with each lens being structured to interchangeably mount to the housing to, in use, shape light emitted from the COB LED module into a respective light beam that is different from the respective light beams produced by the other lenses of the plurality of lenses.

19. The luminaire of claim 18 in which each lens produces a respective light beam that has one or more of:
a different beam angle than other lenses of the plurality of lenses;
a different light focus distance than other lenses of the plurality of lenses; and
a different light pattern than other lenses of the plurality of lenses.

20. The luminaire of claim 18 in which the COB LED module is structured to produce light of a color temperature within the range of 1800 to 2200 K.
